(19) United States
(12) Patent Application Publication
(10) Pub. No.: US 2020/0139225 A1
(43) Pub. Date: May 7, 2020

(54) METHOD AND SYSTEM FOR ONLINE SPEED QUIZ GAME BASED ON MULTIPLE CORRECT ANSWER-EQUIPPED QUIZ

(71) Applicant: KSEEK CO., LTD., Daejeon (KR)

(72) Inventor: Young Real KIM, Daejeon (KR)

(21) Appl. No.: 16/310,590

(22) PCT Filed: Dec. 19, 2017
(86) PCT No.: PCT/KR2017/014983

§ 371 Date: Dec. 17, 2018

(51) Int. Cl. A63F 9/18; A63F 13/352; A63F 13/46; A63F 13/843; G09B 7/073

(52) U.S. Cl. CPC A63F 9/183; A63F 13/352; A63F 2300/8064; A63F 13/843; G09B 7/073; A63F 13/46

(57) ABSTRACT

A method and a system for providing an online quiz game service where participants input answers using their quiz terminals with respect to multiple correct answers to a single quiz question, and the corresponding answer is transferred to a quiz server, the quiz serve receives the answer and judges whether the quiz answer satisfies a specific non-published correct answer among the plurality of correct answers. When the answer does not satisfy any correct answers, the answer is judged as an incorrect answer. Also, when it receives the correct answer judgment at more than a predetermined number of times, the specific correct answer is published.

### BACKGROUND

The present invention relates to a system and a method for providing a quiz game to participants using a quiz terminal by using a quiz question in which multiple correct answers are specified. More particularly, the present invention relates to a quiz game service technique for competitively getting each correct answer of a quiz question having multiple correct answers by a quiz server accessing a plurality of quiz terminals used by a plurality of participants via a network means. In the present invention, the quiz server receives answer from the quiz terminals and judges whether there is a satisfying specific correct answer among multiple correct answers, reflects the judgment result to quiz participants or teams, publishes the specific correct answer judged as the correct answer, and continues the quiz game for the remaining non-published correct answers.

In the whole specification, a quiz server refers to a server which is connected to a plurality of quiz terminals by means of a network means and is capable of receiving answers from a quiz terminal. The quiz server may be provided as a separately designed HW system for providing a quiz game. In addition, the quiz server includes a hardware device such as a PC, a tablet PC, a smart phone etc., and a SW that operates in accordance with the purpose of the present invention.

In the whole specification, the quiz terminal is a terminal that is connected to the quiz server by means of the network means and is used by quiz participants so as to participate in the quiz game. The quiz terminal consists of HW and SW. The quiz terminal is based on a hardware device that optionally includes a network module, an input module, and an output module as needed. The quiz terminal is composed of a combination of software that receives answers from a specific device system and transmits the answers to the quiz server. The hardware device of the quiz terminal may be specially designed for the purpose of the present invention. In addition, the quiz terminal can be selectively adopted among HW devices such as a smart phone, a mobile phone terminal, a PC, and a tablet PC etc., which are widely used. The SW of the quiz terminal performs a function such that the participants input the answers using the quiz terminal or output released data received from the quiz server.

In the whole specification, a multiple correct answer quiz is defined as a quiz that includes two or more correct answers and is independently determined as to whether the quiz answer of the participant is coincided with each correct answer or not. Each correct answer included in the plurality of correct answers of the plurality of quizzes is used to discriminate the answers received from the quiz terminals. Where the quiz question is “What is the name of the fruit?”, The multiple correct answers may be ‘apple, pear, strawberry, melon, peach, cherry, plum, watermelon, ginkgo nut and so on’. Here, when receiving ‘pear’ from the quiz terminal, it is determined that the multiple correct answer quiz only matches the partial correct answer to ‘pear’. If several people repeatedly input “strawberry”, “melon”, etc., it is accepted as correct answer. The plurality of correct answers may contain all the answers, or may include a limited number of answers of satisfying the quiz question.

In the whole specification, the quiz solving is a unit of a quiz game in which a score is obtained by inputting the answers through the plurality of participants using specific quiz questions. One quiz game is composed of several quiz questions and each quiz question is configured to repeat the beginning and end of the quiz solving.

In the whole specification, a publication terminal is connected to the quiz server by means of the network means, and is a terminal system for receiving and outputting published data from the quiz server. The publication terminal includes a combination of a HW and a SW with publication function. The publication terminal receives correct answers or quiz hints etc. published from the quiz server and outputs publication materials such as publication correct answers and quiz questions so that a plurality of quiz game participants can recognize them. The publication terminal is provided with an output module such as a display and a speaker capable of outputting data to be published. In the case of a bidirectional broadcasting in which a viewer participates in the smart phone of utilizing the system constituted by the present invention, a TV may be the publication terminal. In the case of providing the quiz game in a classroom, a beam projector and a PC connected thereto become the publication terminal.

In the whole specification, The participant uses a quiz terminal and refers to a user of a quiz game service participating in the quiz game by inputting the answer through the quiz terminal.

There are many kinds of technologies that constitute a quiz terminal and a quiz server online and provide a quiz service to a large number of participants. Among the conventional technologies, there is an Internet quiz service that discloses quiz questions in a quiz server connected to the Internet for a certain period of time, and provides an asynchronous connection to individual participants so as to solve the quiz. Such a quiz service may result in the scoring of the quiz answer when participating in the quiz game for each participant, so that the answers may be easily exposed to other participants. Such quiz questions are usually provided with easy quiz questions and light gift quiz questions for specific promotional purposes. However, it is not suitable for service of quiz games that cause enthusiastic competition.

In other conventional techniques of the quiz game designed for a broadcast program, the participant is dropped out of the quiz game, if it cannot solve the quiz question at every quiz stage, the final winner can be awarded, if all 50 quiz questions must be met or he passes all the specified stages. However, in these conventional techniques, since peoples write the question in the analog method and the manager manages the scoring and dropout thereof, there is a possibility of making a mistake in the scoring process. Also, it is difficult to completely prevent the change of answer owing to insufficient management thereof.

There is a conventional technique of providing a quiz game in which a plurality of quiz game participants using a plurality of quiz terminals are competed in real time for each quiz step based on a plurality of quiz questions in one quiz session. In this technique, when each participant inputs answers to the quiz terminals server equally in each quiz step and transmits them to the quiz server, the quiz server receives the answers for a predetermined time and then, is determined as to whether the answers inputted by each participant are coincided with correct answer or not, so that the result is reflected to each participant. There is a service for determining the final winner by ranking accumulated points, after all the quiz steps are finished. However, in the case of a specific quiz question including a plurality of correct answers, when various participants input answers, which are assumed to be correct answer, thereto, it is determined as to whether the answers inputted by each participant are coincided with the specific correct answer among the plural ring answer or not and the specific correct answers are published. At this time, there is still a limit to continuously provide the quiz service for the correct answers, which are not published.

The conventional technique consists of a method of obtaining a score and terminating a quiz question when one correct answer is obtained for one quiz question. As correct answers to the quiz question “what is the name of a country in Europe?”, there are UK, Germany, France, Sweden, Denmark, Greece, Italy, Ireland, Luxembourg and so on”. At this time, a large number of people enter the name of the European country one by one, and the participant, who first matches the specific correct answer included above, gets the score, and the specific correct answer is published to several participants. However, with this conventional technique, it is still difficult to provide a tense quiz game in a way that continues the quiz for the remaining correct answers, which are not published.

### SUMMARY OF THE INVENTION

Conventional techniques have a limitation in configuring a speed game that a plurality of participants can enjoy with quiz terminals by using a quiz including multiple correct answers. Particularly, in the case of a quiz with multiple correct answers, it is difficult to configure a quiz game in which people compete with each other by quickly getting and publishing some correct answers among the multiple correct answers.

The present invention has been made in an effort to implement a technique for providing an online speed quiz game using multiple correct answers so as to judge a correct answer when a specific participant first gets a correct answer among multiple correct answers by using a quiz configured by the multiple correct answers in an online game quiz in which a plurality of participants participate using quiz terminals, reflect the judgment result to the specific participant, publish the specific correct answer judged as the correct answer to the participants, and further get non-published correct answers.

In order to solve the above problems, the present invention proposes a system including a quiz server (100), a quiz terminal (200) and a publication terminal (300) for providing a quiz game using a quiz to which the plurality of answers are assigned. The present invention also provides a method for executing an online speed quiz game utilizing quiz questions including the plurality of answers.

The present invention proposes a quiz terminal directly used by a participant, a quiz server connected to a quiz terminal by the network means and capable of transmitting and receiving data, and a publication terminal a connected to the quiz server by the network means and outputting correct answers that received correct answer judgment. Here, the quiz terminal transmits the answer to the quiz server when the participant inputs the answer and the quiz server plays the role of operating the quiz game.

The quiz server prepares the quiz with the plurality of correct answers and allows connection with the plurality of quiz terminals. The quiz server receives the answers to the specific quiz question from the quiz terminal. Also, quiz server determines whether the answer received from the specific quiz terminal satisfies one of the plurality of correct answers and reflects the judgment result to the specific participant or the team. The method of reflection can be variously applied to at least one of counting the number of correct answers of the specific participant or the team, adding or subtracting scores of the specific participant, passing or failing the quiz step, and maintaining the participation status.

The quiz server transmits the specific correct answer to the publication terminal so as to publish the specific correct answer when the participants have met a certain right correct answer among a plurality of correct answers as many as the number of times and the publication terminal publishes the received publication correct answers, so that the participants can recognize the received publication answers. A method for publishing the publication correct answer through the publication terminal outputs using an output device such as a sound and a display etc.

The present invention additionally provides a solution for allowing the quiz terminal to perform the role of a publication terminal without separately providing a publication terminal in the above configuration. In this case, the quiz server transmits the publication data to be sent to the quiz terminal, and the quiz terminal receives the publication data and outputs it so that the participant can recognize it.

The present invention provides a method for providing an online speed quiz game based on a multiple correct answer-equipped quiz which provides a quiz game to a plurality of participants using a quiz server connected with a plurality of quiz terminals via a network means, the method including the steps of preparing, by the quiz server, a quiz question specified with multiple correct answers; publishing, by the quiz server, the quiz question to the participants; transmitting, by the quiz terminal an answer to the quiz server when the specific participant inputs the answer through the quiz terminal; receiving, by the quiz server, the quiz answer from the quiz terminal; judging, by the quiz server, whether the quiz answer satisfies a specific non-published correct answer among the plurality of correct answers; reflecting, by the quiz server, a judgment result for the answer to a specific participant or team; specifying, by the quiz server, the specific correct answer as the published correct answer when the number of times of correct answer judgment is satisfied as many as the number of times required for the publication of the specific correct answer; and transmitting, by the quiz server, the related data to the quiz terminal or the publication terminal in order to publish the published correct answer.

According to the present invention, it is possible to provide a smart learning event, in which learning contents are gamified for the plurality of users using a plurality of smart phones and PCs etc. In particular, it is possible to implement the quiz game in which the plurality of answers of constituting one topic are used as the plurality of correct answers, causing the participants to compete with some unfamiliar answers and to raise their intellectual ability through notices.

The present invention can provide the quiz game service of a different type of fun in which it is solved by competitively completing the plurality of correct answers having a series of constituent requirements under the participation of peoples and can be utilized as learning contents.

In addition, according to the present invention, various quiz game services can be implemented by utilizing the number and position of the remaining correct answers through the publication of the number of correct answers and the correct answers to be solved.

The quiz questions applicable to the embodiments of the present invention may be of various types. That is, it can be composed of various quiz questions such as “input king's name of the Joseon Dynasty”, “cities and countries Chungcheongnam-do, Korea”, “name of our class students”, “fruit name”, “flower name”, “national park?”, “crustaceans?”, “insect name”, “constellation”, “livestock”, “national capital”, “Korean city”, “American city”, “company name”, “port name”, “former presidents”, and “University” etc. and various correct answers corresponding to the questions. By using this quiz question, it can get a learning effect on a number of data that are characteristic to the participants.

### BRIEF DESCRIPTION OF DRAWINGS

The above and other objects, features and advantages of the present invention will be more apparent from the following detailed description taken in conjunction with the accompanying drawings, in which:

FIG. 1 is a schematic diagram of a system for providing a quiz game utilizing a quiz having multiple correct answers;

FIG. 2 is an embodiment of a publication terminal utilizing a display; and

FIG. 3 is a flow chart for proceeding a quiz game using a quiz having multiple correct answers.

### DETAILED DESCRIPTION OF THE INVENTION

Since the description of the present invention is a mere embodiment for structural and functional description, it must not be interpreted that the scope of the present invention is limited by the embodiments described in the text. That is, since the embodiments can be variously changed and have various forms, it should be understood that the scope of the invention includes the equivalents for realizing the technical concept. Also, since the specific embodiments do not include all objects and effects presented by the present invention, the scope of the present invention is not limited by them.

This invention can be implemented in many different forms without departing from technical aspects or main features.

Therefore, the implementation examples of this invention are nothing more than simple examples in all respects and will not be interpreted restrictively.

Even though the terms such as 1, 2, and others can be used to explain many components, the above components shall not be limited by the above terms.

The above terms are used only to distinguish one component from the other component.

For example, the first component can be named the second component without departing from the scope of rights in this invention. Similarly, the second component can be named the first component.

The term called “and/or” includes the combination of the plural described and related items or a certain item of the plural described and related items.

When it is mentioned to be “connected” or “linked” to the other component, a certain component may be connected or linked to the other component. However, it will be understood that there may be some other components between them.

On the other hand, when it is mentioned to be directly “connected” or “linked” to the other component, a certain component will be understood that no other component exists between them.

The terms used in this application do not intend to limit this invention, but are used only to explain specific implementation examples.

The singular expression includes plural expressions unless it is apparently different in the context.

The terms such as “include”, “equipped” or “have” in this application intend to designate that the feature, number, stage, movement, component, part or the combination described in the specification exist.

Therefore, it will be understood that the existence or the additional possibility of one or more than one different features, numbers, stages, actions, components, parts and the combination is not excluded in advance.

Unless differently defined, all the terms used here including technical or scientific terms have the same meaning with what is generally understood by one who has common knowledge in the technical field that this invention belongs to.

The terms such as those defined in the dictionary commonly used will be interpreted to have the meanings matching with the meanings in the context of the related technologies. Unless clearly defined in this application, they are not interpreted as ideal or excessively formal meanings.

The desirable implementation examples in accordance with this invention are explained in detail in reference to the drawings attached below. But, the same reference numbers are given to the same or corresponding components regardless of drawing codes and repeated explanations will be omitted. The detailed description about the prior related technology will also be omitted when it is judged to blur the gist of this invention in explaining this invention.

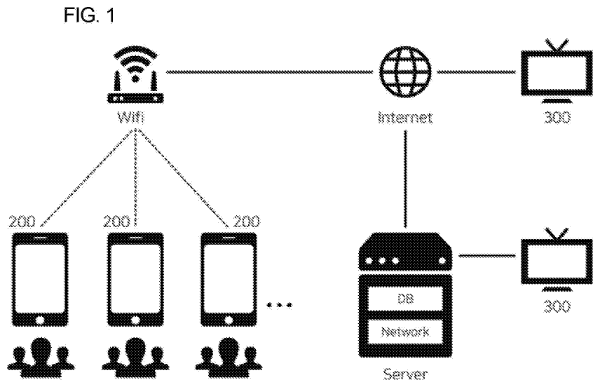

An exemplary embodiment of the present invention will be described with reference to FIG. 1. In FIG. 1, a quiz server (100) includes a network module and is located in an environment capable of transmitting/receiving data with a quiz terminal (200) or a publication terminal (300). In the present invention, in a quiz game service, in order to support a form in which at least two persons competitively answer the same quiz at the same time, quiz terminals need to be always configured in plurality, and the quiz server distinguishes the respective quiz terminals 200 by means of a participant, an ID, a login number, an IP address, an access port, an access sequence, and the like.

Although the quiz terminal (200) and the publication terminal (300) are displayed separately from each other in the drawing, if necessary, the quiz terminal may have a structure having no publication terminal (300) while being designed to perform a publication function. In addition, although not shown in FIG. 1, an operating terminal accessing the quiz server (100) in remote may be further included.

The quiz server (100) is constituted by one computer in FIG. 1, but the quiz server (100) may also be configured by a plurality of distributed servers for maintaining the access to prepare a large number of participants, and may also be configured by combined servers performing the same function.

In the present invention, it is preferable to separately configure an operating terminal or to further include an input module capable of inputting an operation command to the quiz server by an operator so that the operator may operate the quiz game. The operator may determine the difficulty of the question, correct the question, command starting and ending of the quiz game or the quiz step using a specific quiz question, and perform an operating behavior such as publishing hints while engaging with the participants for the remaining non-published correct answers.

In the present invention, the quiz terminal (200), the publication terminal (300), the operating terminal, and the like may all be configured by dedicated HW for performing specific functions and may operate by SW for performing the corresponding functions in a universal PC and a smart phone. That is, when SW having different functions is operated in a same machine, the terminals may be configured as separate terminals according to SW.

In the present invention, the quiz terminal (200), the publication terminal (300), and the operating terminal may be distinguished by operating differently according to a different purpose while using the same SW in the same HW system. That is, when the quiz server is implemented based on a web server, it is possible to design such that different web browsers are executed on one PC and each web browsers perform respective functions of the quiz terminal, the publication terminal, and the operating terminal. When the SW of the quiz server is provided with a daemon program supporting a TCP socket method for maintaining multiple access, the quiz terminal may also be configured to be accessed by a TCP socket communication method.

The quiz server is configured by a combination of SWs that perform the function of the quiz server of the present invention together with the HW. The HW includes a first method for designing a separate system for completing the present invention and a second method for using HW such as various computers which are generally widely spread. The SW is operated in consideration of the HW characteristics, and needs to have an operation function for realizing a technical level proposed in the present invention.

A representative example of the quiz server may be a server system that allows internet access. The SW may be divided into an OS and an application, and an application that performs a function of the quiz server may be prepared separately. The application may be prepared in a daemon type of the quiz server SW so that a large number of participants can be enabled at the same time and may be connected to a plurality of quiz terminals or publication terminals through a socket multiple access processing.

Generally, one of operating systems such as Linux, MS Windows, or Unix is selected and provided in the HW widely spread, a web daemon is installed on the operating system, and then a web application is prepared by a program method such as PHP, JSP, ASP, and CGI executed in the web daemon to make SW for operating a quiz game. The methods presented here are intended to introduce some of the various possible methods, and the present invention is not limited thereto.

The quiz server (100) allows the plurality of quiz game participants using the quiz terminal (200) to manage personal score system. In order to manage the history of the participant, a log-in method using an ID and a password may be applied, or the participant may be distinguished by simply distinguishing by information of the quiz terminal used by the user or a user's name.

It should also be considered that the quiz server (100) divides a plurality of quiz game participants using the quiz terminal into a plurality of teams to provide a quiz game. There is a method of automatically dividing a team depending on gender or affiliation with a specific group, or a method of configuring a team depending on the application of the participant and approval may be applied. In order to provide a team game, a color symbolizing the team, a representative, a team name, a team logo, etc. are selectively specified, and the team's score and the like may be separately managed.

The quiz server distinguishes each multiple correct answers for a quiz question having multiple correct answers, judges whether a specific correct answer is satisfied among the multiple correct answers in a specific answer, manages whether or not to publish the correct answer, and counts the number of correct answers. In addition, the quiz server allows access to a plurality of participants, manages their scores individually, or manages a correct answer judgment history at a specific question step.

The quiz server (100) has a judgment function that may determine whether an answer received from the quiz terminal (200) satisfies a specific non-published correct answer among the multiple correct answers. According to the judgment function, a result of judging the answer is defined as a judgment result and the judgment result is given to the specific participant or team.

The correct answer judgment function of the quiz server (100) is to judge a correct answer if a specific answer satisfies a specific non-published correct answer among the multiple correct answers and to judge an incorrect answer if not. That is, the result of judging the correct answer or the incorrect answer is obtained.

The judgment function of the quiz server (100) may be provided by various methods. For example, there is a means of verifying whether the answer exactly matches the specific correct answer. When the quiz question is “city of the Republic of Korea” and multiple correct answers correspond to “Seoul, Busan, Daegu, Daejeon, Gwangju, Chungju, Chuncheon, Suwon, Gangneung, Wonju, Jeonju, Seongnam, Jeju, Changwon, Pohang, Ulsan and Incheon”, the answer may be judged as the correct answer when it exactly matches the correct answer “Seoul”.

The judgment function of the quiz server may be performed extensively by utilizing artificial intelligence, an image decryption function, a voice decryption function, a semantic comparison function, and the like. When the received answer is input as “Seoul City” or “Seoul Metropolitan City”, it is judged that the correct answer is gotten based on similarity.

There is also a method of allowing the quiz server to specify the specific correct answer in the form of “Seoul or Seoul City or Seoul Metropolitan City” and judge that the specific correct answer is satisfied if the received answer satisfies only one of the forms. The method may be easily applied as compared with the method including functions such as an image decryption function, a voice decryption function, and a semantic comparison function.

The quiz server (100) transmits the judgment result of the answer or a reflection result of the judgment result to the quiz terminal (200) or the publication terminal (300). When the quiz terminal (200) or the publication terminal (300) receives the judgment result or the reflection result, the quiz terminal (200) or the publication terminal (300) outputs the judgment result or the reflection result so as to be recognized by the quiz participants.

When the number of times when the specific correct answer is satisfied in the correct answer judgment step for the specific answer satisfies the number of correct answers required for publication of the specific correct answer, the quiz server (100) switches the specific correct answer to the published correct answer and transmits the published correct answer to the quiz terminal (200) or the publication terminal (300). The number of correct answers required to publish the specific correct answer may be modified and applied as the number of times of accumulatively getting correct answers required for publication, and the number of times of correct answers judgment or the number of correct answers required for publication may be adjusted according to the situation of the quiz game.

The first thing that can be thought as the criterion of the number of times of judging correct answers for publication is once. This is to publish the corresponding specific correct answer when a specific participant gets the correct answer once. This may be considered when there are a few participants, and a person who first gets the correct answer among the participants notifies the fact and the correct answer is leaked, or when the leaked correct answer has a large impact on fairness.

Another criterion of the correct answer publication may be a method of specifying a relatively large number such as 100 times or 2000 times to a specific correct answer. This may be applied to a quiz show in which a large number of viewers participate as a broadcast program. If tens of thousands of viewers become participants, only a few of persons can get the multiple correct answers included in the quiz question, and as a result, most users will not be able to get the score even if they input the correct answers and thus the fun to participate the quiz game may be reduced. In this case, the number of times is increased so that many people can get the answer of a quiz. However, it is preferable to make a ratio to be reflected differently to the person who gets the answer first and the persons who gets the answer later in such a manner as to give a relatively small score when the correct answer judgment order is late or the time is delayed.

Another criterion of the correct answer publication may be a method of increasing the number of the first specific published correct answer and the second specific published correct answer. This method is useful for constituting a quiz game using the recognition difference of each correct answer included in a plurality of correct answers.

For example, in the quiz of “Name a king of Joseon.”, it is possible that people usually know the King Sejong among the multiple answers of “Sejong, Taejong, Seongjong, Cheoljong, and Heonjong”. In this case, Sejong may be a correct answer first published by the people. It is possible to obtain an effect of notifying a less known information by giving opportunities to a relatively small number of participants to get the correct answer with high recognition, and giving opportunities to a relatively large number of participants to get the correct answer with low recognition.

The number of times of judging correct answers required to publish a specific correct answer of the quiz server (100) may be applied in various ways.

The quiz server (100) reflects the judgment result on the answer to the specific participant or the team. It is the most common method to add or subtract scores to or from the specific participant or the team with respect to the judgment result.

The quiz server (100) may count the number of incorrect answers and the correct answers of the specific participant or the team and reflect the counting result to the specific participant or team by a publication method. It is also possible to assign a prize to a specific participant or his team that received correct answer judgment, or to reflect to the judgment result by a method of publishing whether the specific participant and the specific team got the correct answer.

When the quiz server (100) reflects the judgment result regarding the incorrect answer and the correct answer of the specific participant or team by publication, the published data is transmitted to the publication terminal or the quiz terminal, and when the publication terminal or the quiz terminal receives the published data, the published data is output so that the quiz participant may recognize the published data.

Information about the specific participant or team is further included in the published data transmitted to the publication terminal or the quiz terminal by the quiz server (100). The information about the specific participant or team selectively includes information about a cumulative score, an acquired score, a name, an ID, a telephone number, and a symbol color. Corresponding to this, the publication terminal or the quiz terminal is configured to display data about the participant or the team that got the correct answer together with the specific publication correct answer.

The number of times of judging correct answers required to publish a specific correct answer of the quiz server (100) may be set as the number of correct answers for each team. That is, when a same team receives the correct answer judgment at more than a predetermined ratio or a predetermined number of times, the team is deemed to get the specific correct answer and it is published. When a plurality of team participates, if the number of team members do not match each other, it is advantageous to process as being published when a certain ratio of team members gets the correct answer. In order to compare the number of correct answers for each team, the quiz server (100) should be provided so as to accumulate the number of counts for a specific correct answer for each team.

The quiz server (100) is configured, when the participant of team setting a blur color as a symbol color of the team gets the specific correct answer, to send the published correct answer to the publication terminal together with the team color and the team name, and the publication terminal changes a specific area specified for the corresponding specific correct answer to the corresponding team color and outputs the team name and the publication correct answer on the display. The participants see that the color is changed to blue together with the published correct answer and recognize the activity of the team having the team color as the blue color.

The quiz server (100) is configured to include a timer to check a time set in a specific quiz question when a quiz game is started. The quiz server (100) continues the quiz game service of receiving the answer from the quiz terminal and judging and publishing the correct answer until the predetermined time for the specific quiz question is fully exhausted, all of the correct answers are gotten and published, or the operator gives an end command of the quiz game.

In the practice of the quiz system according to the present invention, in order to support an operator to give the end command of the quiz game, a separate operating terminal may be further provided and the operating terminal and the server may be connected to each other by a network means or an input module is directly installed in the quiz server to receive operation-related commands of the operator.

The quiz server (100) including a timer to restrict the quiz game only for a predetermined time is particularly required when there is no operator. If the quiz game does not end because of some correct answers that are difficult to be answered, the quiz game may fall into a mystery, so a preventive measure is needed.

The quiz server (100) further includes a step of publishing non-published correct answers when the quiz game service of the specific quiz question ends with the timer or the end command. The quiz server publishes the correct answers that the participants could not answer so that the participants may verify which answers they have, thereby providing a learning effect. The quiz server (100) transmits data for publishing the correct answers that are not gotten in the specific quiz question to the publication terminal or the quiz terminal, and the publication terminal or the quiz terminal receives the data from the quiz server and outputs the data so as to be recognized by the participants.

There are two methods in which the quiz server (100) publishes a specific correct answer among the plurality of correct answers. The first method is a method of transmitting a published correct answer to a quiz terminal used by the participants and expressing the published correct answer on the quiz terminal, and the second method is a method of providing a separate publication terminal and outputting the published correct answer by the publication terminal when the quiz server transmits the published correct answer to the publication terminal (300). Only one of the two methods may be selectively configured, or both the two methods may be configured together.

The publication terminal may be configured in a combination of HW such as a laptop PC, a PC, a computer, a smart phone, and a tablet PC and software. In addition, the publication terminal is configured by selectively adopting a monitor, a TV, a speaker, a beam projector, and the like connected to the quiz server.

The method of transmitting the published correct answer to the publication terminal by the quiz server is configured to transmit the data of the published correct answer and output the data by visualization or audioization by the publication terminal. Alternatively, the quiz server may transmit a video signal or an audio signal to the publication terminal, and the publication terminal may receive and output the video signal or the audio signal. The transmission of publication information via TV broadcast may also define the TC as the publication terminal in a broad meaning.

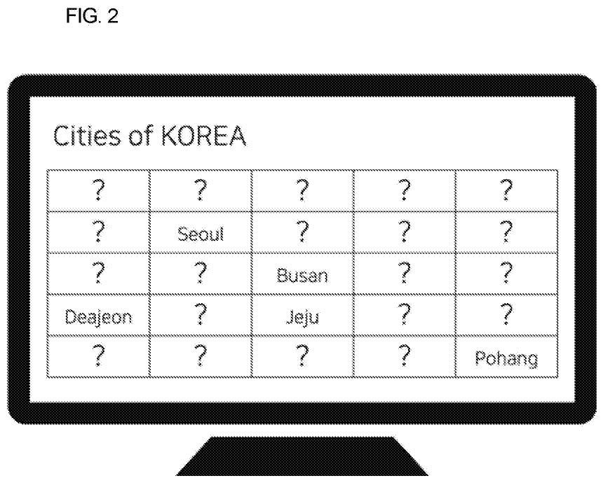

FIG. 2 shows an embodiment of the publication terminal included in the present invention. It will be apparent that the embodiment is an example of a publication terminal distinguished separately, and similar functions may be included in the quiz terminal through function implementation.

The publication terminal (300) is used to notify the quiz question, the number of correct answers included in the quiz, in particular, the number of remaining non-published correct answers. The step of notifying the quiz question is performed in such a manner that the quiz server indicates whether the quiz question or the quiz correct answer is published. At this step, the quiz server transmits related information to the publication terminal, and the publication terminal displays the information to be viewed by the participants.

The publication terminal is configured to output the quiz question, the number of correct answers, published correct answers, blank spaces of the non-published correct answers, etc. The publication terminal may be designed by dividing each function into several types of publication terminals or quiz terminals according to each purpose or designed in combination to perform a complex function on one system.

The quiz server transmits the related publication information to the quiz terminal or the publication terminal so that the question phrase included in the quiz question and the number of the multiple correct answers may be published before the specific published correct answers of the quiz are published. The number of multiple correct answers may be configured by at least one of the number of published publication terminals, the number of non-published correct answers, and the total number of correct answers. There is a method of displaying numbers directly, but the method can be replaced with a method of intuitively recognizing how many non-published correct answers remain.

To this end, the quiz server (100) transmits to the quiz terminal or the publication terminal publication information including information including all published correct answers published until the present and information capable of determining the number of remaining published correct answers. The publication terminal and the quiz terminal receive the publication information and output the numbers of the multiple correct answers specified in the quiz question to be recognized by the quiz game participants. As a method of publishing the numbers of multiple correct answers to be recognized, a method of simply displaying numbers may be used, but in order to produce a more exciting quiz game, an answer card method of displaying blanks or blank cards on the screen may also be used.

As an example of the answer card type publication method, the numbers of cards on which a question mark is drawn is displayed on the screen as many as the number of correct answers, and each time a specific correct answer is published, a card on which a question mark is drawn is replaced with a card marked with the specific correct answer so that the numbers are output to be recognized by the participants. Such an answer card type publication method may be variously implemented through graphic implementation.

In the answer card type, the participants recognize which correct answer is published and the number and the locations of non-published correct answers, and make an effort to get the remaining correct answers.

In addition to a method of changing the specific question mark card to a card marked with a specific correct answer, a method of additionally displaying individual or team information of a person who has gotten the correct answer may also be applied. The individual or team information may be a representative color, or may be a part of a name, a phone number, an ID, a logo, and the like. When the representative color is displayed, the representative color gives an effect of encouraging more competition by visually indicating which person or a specific team got how many of the correct answer in a certain area.

As a method in which the question mark card is changed when the specific correct answer is published, a method of setting a unique location value as each correct answer, a method of arbitrarily setting a location thereof, a method of changing in a published order, or the like may be variously applied. When the specific team or the specific participant gets the correct answer corresponding to a diagonal line or a vertical line and a horizontal line, a method of adding an additional score by automatically calculating the score may be applied.

The publication method may be changed to an image segmentation method by slightly changing the answer card type. In the image segmentation method, each correct answer included in one quiz question holds a specific location on the display or a specific location on a time line, and an image segment is specified for each specific location. Here, the image segment is a part of the data that completes the whole, and is a part of an image, a sound, and a picture. When all the image segments are published at a specified specific location, one whole image may be completed.

In the image segmentation method, when the correct answer at the specific location is published, a predetermined segment image is output at the specific location. As more correct answers are published, more image segments are revealed, and each segment image and video become easier to guess what the whole image means. A separate section that a separate correct answer associated with the whole image is specified, and when the corresponding correct answer is additionally gotten, the answer is judged and reflected may be further configured.

As an exemplary embodiment of a publication method using the image segmentation method, it may be assumed that a whole image is a donkey picture, and a quiz question including multiple correct answers such as “Seoul, Busan, Daegu,” and a question of “Name of the cities in Korea” is used on a publication terminal screen configured by a card picture represented with a question mark configured by a total of 25 spaces consisting of 5 spaces in width and 5 space in length.

In the embodiment of publishing the answer by the image segmentation method, each space corresponds to the specific correct answer. When one participant gets the correct answer of “Seoul”, an image segment corresponding to Seoul is displayed, and when the participant gets the correct answer of “Busan”, the question mark card corresponding to Busan is switched to be translucent or transparent, or the corresponding image of the background image is displayed. Whenever the correct answer is published, the background image is increased. When receiving a “donkey” as an answer from a specific quiz terminal, the answer “donkey” is compared with the correct answer for correct answer judgment and the judgment result is reflected to the specific participant or team.

It is preferable to configure an independent publication terminal to publish the number of the quiz correct answers and to output and publish information about the non-published correct answers and the published correct answers. However, if a separate publication terminal is not configured, the judgment result may be applied to the quiz terminal.

In the embodiment, one publication terminal is displayed, but in an actual implementation, a plurality of publication terminals may be installed. It is also possible to use a plurality of publication terminals by dividing functions, or a plurality of publication terminals performing the same function.

The quiz terminal (200) is configured by a device capable of connecting with a quiz server in a mutually compatible manner, transmitting an answer inputted by a participant and of receiving information such as a published correct answer and a judgment result. It may be preferable to use a transmission/reception method utilizing radio waves, or use HW that supports general data transmission/reception protocols such as an IP network.

The quiz terminal uses a widely used smart phone, a telephone, a PC, a tablet PC, and the like and further includes SW that supports so as to perform a function of the quiz terminal, thereby easily implementing the technique of the present invention.

In configuring a detailed service by using the technique of the present invention, the quiz terminal may be divided into two types of including a publication function or not. Since the publication function of the present invention should be provided in at least one of the publication terminal and the quiz terminal, when the publication terminal is separately present, the quiz terminal does not require the publication function.

The quiz terminal supports a method of logging in to the quiz server by using an ID, a name, a telephone number, an e-mail address, an IP address, and a frequency range that may identify participants. In this case, the quiz terminal includes an input module and an input step, in which data required for login such as an ID and a password are inputted. The quiz server selectively adopts and uses an available method such as a connection management number of a simply connected TCP/IP and the like.

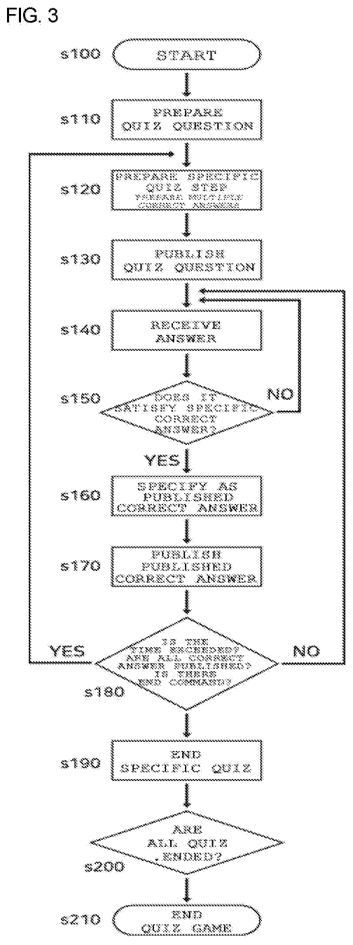

FIG. 3 is a flowchart according to a main flowchart constituting the present invention and shows an example of a series of operations in which the quiz server is operated according to the flowchart.

The quiz server (100) provides a quiz game to a plurality of participants using individual quiz terminal connected by the network means. The quiz server accumulates scores individually for the participants using each quiz terminal or manages data of whether the participant survived and whether they receive the prize.

The quiz server (100) independently accumulates scores with respect to the participant or team participating in the quiz game or manages the number of correct answers and secured scores for a specific quiz question. Further, the quiz server further includes a function of separately arranging the overall ranking of the participant or the team or the personal ranking of the participants in the team.

The quiz server (100) manages separate information of the team for the team game. A variety of information such as a team name, a team color, a team symbol, a team member qualification, the number of team members, scores of the team, and the like is selectively configured and managed.

The step of preparing a quiz question with multiple correct answers by the quiz server (100) selectively includes a pretreatment operation such as securing information about the quiz question by reading it from a DB or receiving or inputting it from the operating terminal, and grasping the number of multiple correct answers included in the quiz question. The step also includes an operation of locating the multiple correct answers on a memory, storing the multiple correct answers in a storage device, or setting the multiple correct answers in a DB, and the like.

The quiz server transmits the information about the quiz question to the quiz terminal or the publication terminal so that the participants may recognize the quiz question. The quiz terminal or the publication terminal receives the information to correspond thereto and display the information so as to be recognized by the participants.

A process of the quiz server (100) according to the present invention will be described with reference to FIG. 3. The quiz server (100) is connected to a plurality of quiz terminals used by a plurality of participants through the network means.

The quiz server (100) performs a quiz question preparation step (S110) to provide a quiz game. The step corresponds to a step of preparing the plurality of quiz questions.

The quiz server (100) prepares a quiz solving step of a specific quiz question having multiple correct answers (S120). In this step, the quiz server is prepared by a method suitable for grading multiple correct answers included in one quiz question. That is, when there are many multiple correct answers, the scoring of the answers may be researched in a binary tree by sequentially sorting the multiple correct answers. Alternatively, the multiple correct answers are displayed on the memory to be rapidly calculated. Here, the multiple correct answers are all treated as non-published correct answers.

The quiz server (100) publishes the quiz question to the publication terminal (300) or the quiz terminal (200). The publication method is a method of transmitting the publication data including the quiz questions, the number of answers to be published, and the like to the publication terminal or the quiz terminal. The publication terminal or the quiz terminal receives the publication data, displays the quiz question so as to be recognized by the participants, and outputs the numbers of the quiz answers.

When the quiz server (100) starts the answer reception from the plurality of quiz terminals and receives the specific answer from the specific quiz terminal (S140), the quiz server (100) performs judging (S150) whether it satisfies a specific correct answer among non-published correct answers. In the correct answer judgment step, if the answer satisfies the specific correct answer among non-published correct answers, the answer is judged as the correct answer, and when the answer does not satisfy any correct answers among the non-published correct answers, the answer is judged as an incorrect answer. The judgment result for the specific answer is divided into correct answer judgment and incorrect answer judgment.

In the case of a live quiz show, a lot of users may be attracted. Assuming that 100,000 participants each input the answers and there are 64 non-published correct answers, just the number of sequential string comparisons performed to judge the correct answer would be 3.2 million times. Therefore, in order to process judgment step rapidly, in the multiple correct answer preparation step (S120), a judgment method of sequentially arranging a plurality of correct answers and finding with a binary tree whether a specific correct answer is satisfied in the correct answer judgment step should be implemented. In this case, the number of comparisons of 3.2 million times is reduced to 0.7 million times, which reduces the load on the quiz server in advance.

The quiz server (100) further includes a section of reflecting the judgment result to the specific participant or team with respect to the judgment result, although not illustrated in the flowchart of FIG. 3. A method of disqualifying the specific team or participant or taking out the scores when the answer is judged as the incorrect answer is a reflection method which may be very basically performed. A method of keep qualifying the specific team or participant, providing a prize, reflecting scores, and the like may be basically used with respect to the correct answer judgment.

The quiz server (100) designates the correct answer as the published correct answer (S160) when the number of times of correct answer judgment of the specific correct answer satisfies the number of times of correct answer judgment required for the publication when the judgment result is the correct answer judgment for the specific correct answer.

The quiz server (100) publishes the published correct answer through the quiz terminal or the publication terminal. The publication method is to transmit the publication data including the published correct answer to the publication terminal or the quiz terminal and have the publication terminal or the quiz terminal receive and output the publication data.

The quiz server (100) ends the quiz solving in progress when the current quiz solving exceeds a time specified in the specific quiz question in progress, all correct answers are published, or there is an end command from the operator. The end command from the operator selectively includes a method of receiving an end command from an operating terminal or receiving an end command directly from the quiz server.

The quiz server (100) ends the quiz game after performing the quiz solving for all quizzes having the multiple correct answers. It is preferable to add a step of publishing the final winner or the final winning team at the end of the quiz game.

The information about the quiz question may include information about the number of correct answers included in the quiz question and the location and order of the non-published correct answers, and may further include information about a question phrase or a specific image segment.

The quiz terminal is configured with an input module so that a specific participant may input an answer to the quiz terminal. The input module selectively uses a mouse, a keyboard, a microphone, a touch pad, and the like. When the participant inputs an answer to the quiz terminal using the input module, the quiz terminal transmits the inputted answer to the quiz server.

The quiz server (100) performs a judgment process of verifying whether the quiz answer corresponds to the specific non-published correct answers among the multiple correct answers. The quiz server derives the judgment result through the judgment process for the specific answer. The judgment result is divided into correct answer judgment, incorrect answer judgment, and the like.

Here, the correct answer judgment is interpreted as satisfying at least one correct answer among the multiple correct answers included. The judgment method of whether a specific answer satisfies a specific correct answer among multiple correct answers may be extended as much as possible according to how a technical method of comparing a specific answer with a specific correct answer is combined.

As an easy judgment method widely practiced, there is a method of comparing whether the answer is a string that matches some correct answers. A method of constituting a plurality of words with similar meanings in a specific correct answer and judging answers that match some of the words or including the words as correct answers is an easily implemented example.

A method of judging an answer based on a correct answer condition may be used as a more extended judgment function. For example, with respect to multiple correct answers such as “odd numbers, fractional numbers, even numbers, and irrational numbers”, it is possible to judge a correct answer based on whether the condition is met as judging that the answer of “1” satisfies the correct answer of “odd number” and the answer of “2” satisfies the correct answer of “even number.

As another embodiment of the judgment function, there is a method in which the quiz server adopts a specialized data analysis function. For example, if a quiz question is an “animal sound” and multiple correct answers are “a horse sound, a cow sound, a bird sound, a pheasant sound, and a chick sound”, when a specific participant records the chick sound and transmits the recorded data, the quiz server may receive and analyze the data to judge the data as a correct answer for the “chick sound”. The method of distinguishing the chick sound may be implemented by various methods such as conventional pattern recognition. In addition to this method, it is possible to judge whether a specific correct answer is satisfied by analyzing a picture image and a voice received as an answer from the quiz terminal.

The quiz server judges as an incorrect answer when the correct answer judgment is not performed with respect to all non-published correct answers not published until the judgment point for specific answer.

In the present invention, the quiz server may further include a step of publishing the quiz question in addition to the function of publishing the correct answer. In other words, the publication of the quiz question may be implemented by transmitting the related information to the quiz terminal or the publication terminal in order to publish a question phrase of the quiz question or the number of non-published correct answers so far, and outputting the related information by the quiz terminal or the publication so as to be recognized by the participants. The number of non-published correct answers may be simply expressed in numbers, but it is also possible to use a method of guessing the numbers of non-published correct answers such as image segment and answer card methods.

The quiz server (100) transmits the related information to the quiz terminal or the publication terminal if necessary with respect to the result of correct answer judgment for specific answer. The information related to the result of the correct answer judgment may selectively include information such as whether a specific answer is incorrect or correct, the number of times of receiving the specific incorrect answer, the number of times of receiving the specific correct answer, and a participant and a team who transmitted the specific answer.

If the quiz server publishes the result of counting specific answers processed as incorrect answers to the publication terminal or the quiz terminal, a possibility of the participants finding an answer except the corresponding incorrect answer is increased. In addition, weird and laughable answers may further increase the appealing power of the quiz game.

The quiz server counts the result of the correct answer judgment and publishes the correct answer when the number of times of getting the correct answers is equal to or more than a predetermined number of times. As the most common method of publishing the correct answer, there is an example of publishing the specific correct answer immediately when the specific correct answer is first gotten. This is useful for participants who have relatively few class units.

In the quiz game, which is performed with a quiz question including a question of “Name of the cities in Korea” and multiple correct answers of “Seoul, Busan, Daegu, Daejeon, Gwangju, . . . ”, when the corresponding correct answer is published whenever participants get a specific correct answer once, other participants will make an effort to get the names of other cities as many as the number of non-published correct answers.

When the number of times of correct answer judgment required for publishing a specific correct answer is set to 2 or 3, there is an effect that two or three persons who quickly input each answer receives correct answer judgment, that is, a multiple correct answer judgment occurs. The method of separately designating the number of correct answer judgment required for publishing each correct answer may also be applied. In this case, it is possible to make a change in the fun of participating the quiz game by separately specifying the number of times of getting correct answers depending on whether many people are unfamiliar or familiar with the correct answer.

Particularly, in an online quiz game which has a large number of participants and is distributed in various places, the number of correct answer judgment required for publishing a specific correct answer may be specified as 100 or more numbers so as to increase the participation intention of the participants.

The number of times required for publication of the specific correct answer may be set to increase or decrease gradually according to the order in which the correct answer is published. In the case of a familiar correct answer, a large number of people compete to input an answer, so only a small number is set to receive the correct answer judgment at the beginning, and in the case of an unfamiliar or very difficult correct answer, the number of times of correct judgment required for publication may gradually increase such that persons who get difficult answers may get more opportunity of correct answer judgment.

In the embodiment of the present invention, the quiz server manages the plurality of correct answers specified for a specific quiz question by dividing the correct answers into before publication and after publication. Here, the non-published correct answers are divided into correct answers that will not be published, correct answers that are determined to be published, or correct answers that are included in the publication information and transmitted to the quiz terminal or the publication terminal.

The quiz server may further have a step of accumulating the judgment result. The accumulation is performed to accumulate the number of correct answer judgment received in a specific question for each user with respect to a specific participant or a specific participating team. The quiz server also accumulates the number of incorrect answers or the number of correct answers for the specific quiz question or accumulates the numbers by adding or subtracting scores.

The quiz server may further include a step of setting a time for the specific quiz question and ending the process when all of the included correct answers are published, the predetermined time is exceeded, or the end command is received or inputted.

After performing a one-step service of the quiz game based on the specific quiz question including the multiple correct answers, the quiz server judges the quiz result as ranking, wining or losing, and the like by accumulating the numbers of correct answers or the obtained scores in the specific quiz question for each specific participant or team and reflects the quiz judgment result to the specific participant or team. In the method of reflecting the quiz result, adding or subtracting scores, Winners-win monopoly which gives scores to the winner in the specific quiz step by removing some of scores of the other party, passing or failing in the specific step, and the like may be selectively applied.

1. A method for providing an online speed quiz game based on a multiple correct answer-equipped quiz which provides a quiz game to a plurality of participants using a quiz server connected with a plurality of quiz terminals via a network means, the method comprising the steps of:
preparing, by the quiz server, a quiz question specified with multiple correct answers;
receiving, by the quiz server, an answer of a specific participant from the quiz terminal;
judging, by the quiz server, whether the quiz answer satisfies a specific non-published correct answer among the plurality of correct answers;
reflecting, by the quiz server, a judgment result for the answer to a specific participant or team; and
publishing, by the quiz server, the corresponding specific correct answer when the answer receives the correct answer judgment.

2. The method of claim 1, wherein in the step of publishing the specific correct answer by the quiz server, the number of times of correct answer judgment required for publishing the correct answer is one, the number of times specified differently for each specific correct answer, or the number of times specified differently according to the order of correct answers to be published, and the quiz server publishes the specific correct answer when the number of times of correct answer judgment is satisfied as many as the number of times required for the publication of the specific correct answer.

3. The method of claim 1, further comprising:
ending, by the quiz server, quiz solving of the specific quiz question when a plurality of answers is judged and published as correct answers, an end command is received from an operator, or a time specified in the quiz question is exceeded in a quiz game in progress with a specific quiz question.

4. The method of claim 1, wherein the step of publishing the specific correct answer by the quiz server further includes:
transmitting, by the quiz server, publication data including the specific correct answer to the quiz terminal or the publication terminal; and
receiving and outputting, by the quiz terminal or the publication terminal, the publication data.

5. The method of claim 4, further comprising:
outputting, by the quiz terminal or the publication terminal, the number of published correct answers and the number of non-published correct answers to be recognized by quiz participants.

6. The method of claim 1, wherein the step of publishing the specific correct answer by the quiz server further includes: publishing information further including information about the specific participant or team.

7. The method of claim 1, further comprising:
judging, by the quiz server, a quiz result by accumulating the number of correct answers or obtained scores of a specific user or a specific team and reflecting the quiz judgment result to the specific team or participant again after the quiz solving of the specific quiz question ends.

8. A system for providing an online speed quiz game based on a multiple correct answer-equipped quiz which provides a quiz game to a plurality of participants using a quiz question specified with multiple correct answer, the system comprising:
a quiz terminal which transmits and receives data by accessing a quiz server by a network means, includes an input module which enables a participant to input an answer, transmits the answer to the quiz server when the participant inputs the answer, receives a correct answer to be published from the quiz server, and outputs the correct answer to be published so as to be recognized by the participant; and
a quiz server which is connected with a plurality of quiz terminals by a network means, receives an answer from the quiz terminal, judges whether the answer satisfies a specific non-published correct answers among the plurality of correct answers, and transmits the specific correct answer to the quiz terminal to publish a published correct answer when the number of correct answer judgment required for publication of the specific correct answer is satisfied.

9. The system of claim 8, wherein the quiz server ends quiz solving of the quiz question when all of the plurality of correct answers are published, a specified time is exceeded, or an end command of the quiz question is inputted or received.

10. A system for providing an online speed quiz game based on a multiple correct answer-equipped quiz which provides a quiz game to a plurality of participants using a quiz question specified with multiple correct answer, the system comprising:
a quiz terminal which transmits and receives data by accessing a quiz server by a network means, includes an input module which enable a participant to input an answer, and transmits the answer to the quiz server when the participant inputs the answer;
a publication terminal which outputs a published correct answer received from the quiz server to be recognized by the participant; and
a quiz server which is connected with a plurality of quiz terminals by a network means, receives an answer from the quiz terminal, judges whether the answer satisfies a specific non-published correct answers among the plurality of correct answers, and transmits the specific correct answer to the quiz terminal to publish a published correct answer when the number of correct answer judgment required for publication of the specific correct answer is satisfied.

11. The system of claim 10, wherein the quiz server ends quiz solving of the quiz question when all of the plurality of correct answers are published, a specified time is exceeded, or an end command of the quiz question is inputted or received.
